(19) United States
(12) Patent Application Publication
(10) Pub. No.: US 2025/0357060 A1
(43) Pub. Date: Nov. 20, 2025

(54) FLANGE, NOTCH, OR HOOK ENGAGING PORTION FOR ASSISTING QUICK OPENING OF POWER LINES USING A CUTOUT DOOR

(71) Applicant: Jason WOLF, Taylor, MI (US)

(72) Inventor: Jason WOLF, Taylor, MI (US)

(21) Appl. No.: 19/056,237

(22) Filed: Feb. 18, 2025

Related U.S. Application Data
(60) Provisional application No. 63/731,581, filed on May 14, 2024.

(51) Int. Cl. H01H 17/08; H01H 9/02; H01H 85/055

(52) U.S. Cl. CPC H01H 17/08; H01H 9/02; H01H 85/055

(57) ABSTRACT

An upper tube member for a cutout door of a power line connection includes a cylindrical body configured to receive one end of an insulating tube. A first flange extends in a first radial direction outwardly from the cylindrical body. A pull ring is connected to the first flange, defines a continuous ring opening, and extends in the first radial direction outwardly from the first flange. A second flange extends a predetermined distance in a second radial direction, opposite to the first radial direction, from an opposite side of the cylindrical body and is configured to engage a hook end of a lineman's pole.

### CROSS-REFERENCE TO RELATED APPLICATIONS

This application claims the benefit of U.S. Provisional Patent Application No. 63/731,581, filed on May 14, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to cutouts for power lines, and more particularly to a cutout door including a flange, cavity, or hook engaging portion to assist with disconnecting power lines.

Electricity is carried by a transmission system to consumers. Distribution substations connect to the transmission system and lower a high transmission voltage to a medium voltage using transformers. Primary distribution lines carry the medium voltage power to distribution transformers located near consumers. Distribution transformers again lower the voltage to a utilization voltage supplied by power lines to power consumers. Safely making and breaking connections to the power lines of the transmission system can be difficult since the power lines are typically mounted high above the ground and involve high current and voltage levels.

### SUMMARY

An upper tube member for a cutout door of a power line connection includes a cylindrical body configured to receive one end of an insulating tube. A first flange extends in a first radial direction outwardly from the cylindrical body. A pull ring is connected to the first flange, defines a continuous ring opening, and extends in the first radial direction outwardly from the first flange. A second flange extends a predetermined distance in a second radial direction, opposite to the first radial direction, from an opposite side of the cylindrical body and is configured to engage a hook end of a lineman's pole.

In other features, the predetermined distance is greater than or equal to three-quarters of a diameter of the hook end of the lineman's pole. The predetermined distance is greater than or equal to a diameter of the hook end of the lineman's pole. The second flange is located adjacent to a bottom edge of the cylindrical body. The second flange extends in a range from 5° to 200° in a circumferential direction around the cylindrical body. The second flange extends greater than ¼″ from the cylindrical body.

In other features, the second flange forms an angle greater than or equal to 90° relative to a bottom and radially outer side of the cylindrical body and less than or equal to 90° relative to an upper and radially outer side of the cylindrical body. An upper edge of the cylindrical body of the upper tube member is threaded to receive a cap.

A cutout door for a power line connector includes the cap, the insulating tube, an arc shortening rod arranged in the insulating tube and connected to the cap, a fuse arranged in the insulating tube and connected to the arc shortening rod, and the upper tube member.

In other features, a lower tube member is arranged around an opposite end of the insulating tube. A conductor is in contact with the fuse and extends through the insulating tube and the lower tube member.

An upper tube member for a cutout door for a power line connector includes a cylindrical body configured to receive one end of an insulating tube. A flange extends in a first radial direction outwardly from the cylindrical body. A pull ring extends in the first radial direction outwardly from the flange, defines a ring opening, and includes opposite ends connected to the flange. The pull ring has a shape selected from a group consisting of circular and elliptical. An upper side of the pull ring includes a hook engaging portion extending into the ring opening.

In other features, the hook engaging portion has a shape selected from a group consisting of concave, triangular, and slotted. The flange has a trapezoidal shape. An upper edge of the cylindrical body of the upper tube member is threaded to receive a cap.

A cutout door for a power line connector includes the cap, the insulating tube, an arc shortening rod arranged in the insulating tube and connected to the cap, a fuse arranged in the insulating tube and connected to the arc shortening rod, and the upper tube member.

In other features, a lower tube member is arranged around an opposite end of the insulating tube. A conductor is in contact with the fuse and extends through the insulating tube and the lower tube member.

An upper tube member for a cutout door of a power line connection includes a cylindrical body configured to receive one end of an insulating tube. A flange extends in a first radial direction outwardly from the cylindrical body. A pull ring includes a continuous ring opening, is connected to the flange, and extends in the first radial direction outwardly from the flange. A notch extends inwardly into the cylindrical body on an opposite side of the cylindrical body relative to the pull ring. The notch is configured to engage a hook end of a lineman's pole.

In other features, the notch is located adjacent to a bottom edge of the cylindrical body. An upper edge of the cylindrical body of the upper tube member is threaded to receive a cap.

A cutout door for a power line connector includes the cap, the insulating tube, an arc shortening rod arranged in the insulating tube and connected to the cap, a fuse arranged in the insulating tube and connected to the arc shortening rod, and the upper tube member.

In other features, a lower tube member is arranged around an opposite end of the insulating tube. A conductor is in contact with the fuse and extends through the insulating tube and the lower tube member.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a standard cutout including a cutout door;

FIGS. 2A and 2B are partial side views illustrating examples of cutout doors including flanges located on a side of the upper tube member of the cutout door to facilitate opening of the cutout door according to the present disclosure;

FIGS. 3A to 3D are plan views illustrating other examples of cutout doors including flanges according to the present disclosure;

FIGS. 4A to 4E are side views illustrating an upper tube member including a pull ring with a hook engaging portion according to the present disclosure;

FIG. 5 is a side view illustrating an upper tube member including a cavity for engaging a hook according to the present disclosure;

FIG. 6 is a perspective view of a line break cutout including a cutout door with a flange according to the present disclosure; and

FIG. 7 is a perspective view of a load break cutout including a cutout door with a flange according to the present disclosure.

In the drawings, reference numbers may be reused to identify similar and/or identical elements.

### DETAILED DESCRIPTION

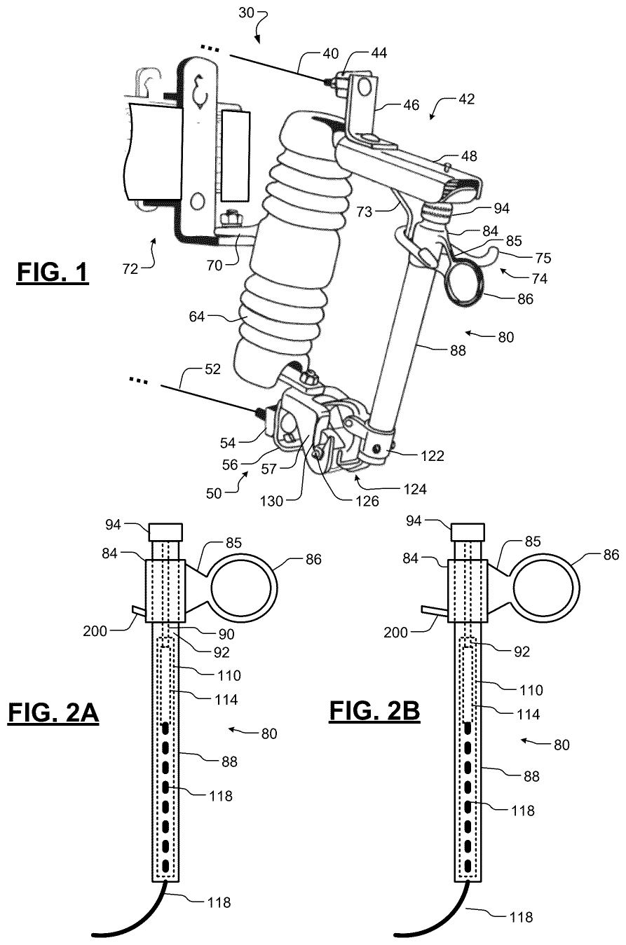

Referring now to FIGS. 1 and 2A, a standard cutout assembly 30 for a first power line 40 and a second power line 52 is shown. The first power line 40 is connected to an upper power line connecting assembly 42 of the standard cutout assembly 30. The upper power line connecting assembly 42 includes a power line connector 44 and upper frame members 46 and 48.

The second power line 52 is connected to a lower power line connecting assembly 50. The lower power line connecting assembly 50 includes a power line connector 54, a lower frame member 56, and a hinge receiving frame member 57. An insulator 64 is connected between one end of the upper frame member 48 and the lower frame member 56. A midportion of the insulator 64 is connected by a frame member 70 to a mounting location 72.

A frame member 73 is connected to the upper frame member 48 and a ring horn 74. The ring horn 74 includes arcuate portions 75 extending around an upper portion of a cutout door 80 and flaring outwardly. The cutout door 80 acts as both a fuse and a switch between the first power line 40 and the second power line 52. In other words, an electrical connection between the first power line 40 and the second power line 52 is typically made or broken using the cutout door 80.

The cutout door 80 includes an upper tube member 84 including a cylindrical body, a flange 85 extending outwardly from the cylindrical body, and a pull ring 86 connected to the flange 85. An upper end of a first insulating tube 88 is inserted in and connected to an inner cavity of the upper tube member 84. A cap 94 is connected to an arc shortening rod 90 (FIG. 2A). The arc shortening rod 90 is fed into an upper end of a cavity 92 defined in the first insulating tube 88. The cap 94 is attached to the upper tube member 84 by threads formed on the upper tube member 84.

A lower end of the arc shortening rod 90 is inserted into a cavity of a second insulating tube 110 located within the cavity 92 of the first insulating tube 88. The lower end of the arc shortening rod 90 contacts an upper end of a fuse 114 arranged in the second insulating tube 110. A lower end of the fuse 114 is connected to a conductor 118 that extends through a bottom opening of the first insulating tube 88 and is connected to the hinge receiving frame member 57 (electrically contacting the second power line 52).

The lower end of the first insulating tube 88 is inserted in and connected to an inner cavity of a lower tube member 122. The lower tube member 122 connected to a hinge member 124. The hinge member 124 includes an axle 126 that is rotatably received in a slot 130 defined by the hinge receiving frame member 57.

The standard cutout assembly 30 is typically mounted high above the ground and at an angle (e.g., 5 to 45°) relative to vertical such that the upper end of the cutout door 80 falls downwardly when the pull ring 86 is pulled. A lineman typically uses a long pole with a hook located at a distal end to engage the pull ring 86 to make or break a connection between the first power line 40 and the second power line 52.

When the lineman pulls downwardly on the pull ring 86 using the hook of the long pole, the cutout door 80 rotates on the axle 126 of the hinge member 124, and the cap 94 breaks contact with the distal end of the upper frame member 48 (which breaks the circuit). As can be appreciated, because the cutout door 80 and the pull ring 86 are located at a relatively high height and the pull ring 86 has a relatively small diameter (particularly from a distance), it may be difficult for the lineman to thread the hook quickly and easily into the pull ring 86 to engage the pull ring 86, which delays breaking the circuit.

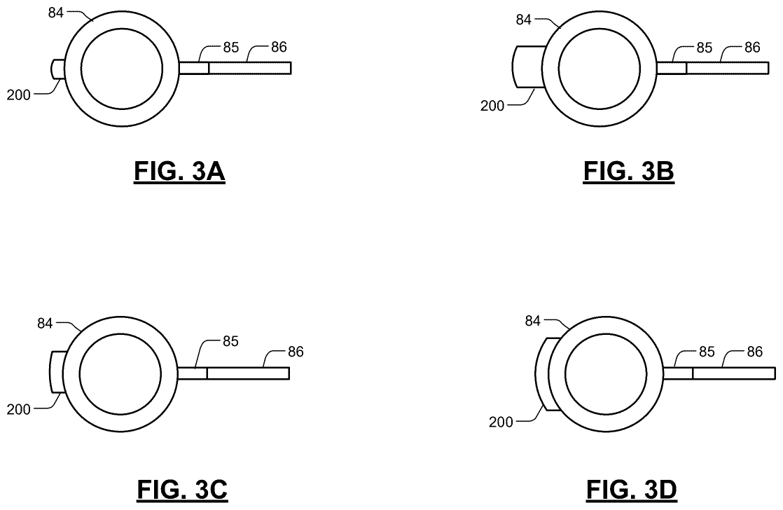

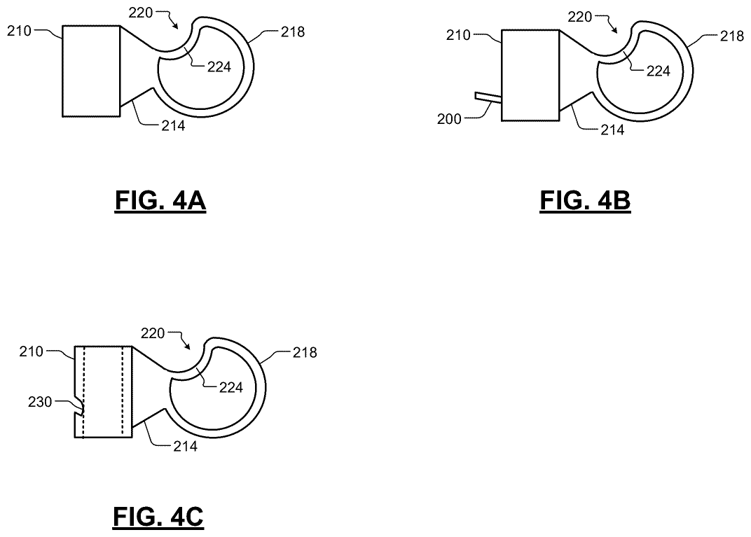

Referring now to FIGS. 2A to 3D, the cutout door 80 according to the present disclosure includes a flange 200 located on an opposite side of the upper tube member 84 relative to the pull ring 86. The flange 200 extends outwardly from the upper tube member 84 by a predetermined distance to provide a surface upon which the lineman can easily and quickly engage the hook. In some examples, the flange 200 extends outwardly greater than or equal to a diameter of the hook. In some examples, the flange is located adjacent to a bottom edge of the upper tube member 84 to allow the hook to slide along the upper tube member 84 and catch the flange 200. In some examples, the flange 200 forms an angle greater than or equal to 90° relative to a bottom and radially outer edge of the cylindrical body and less than or equal to 90° relative to an upper and radially outer edge of the cylindrical body as shown. The angle of the flange 200 is configured to engage the hook as the lineman slides the hook downwardly along the cylindrical body of the upper tube member 84.

In FIGS. 2A to 3D, non-limiting examples of different shapes of the flange 200 are shown. The flange 200 extends from the upper tube member 84 by a sufficient distance both outwardly and circumferentially to allow the lineman to engage the hook of the long pole easily and quickly onto the flange 200 to open the cutout door 80. The amount of skill, time, and effort that is required to place the hook on the upper tube member 84 above the flange 200 is significantly lower, shorter, and easier, respectively, than threading the hook through the pull ring 86. In some examples, the flange 200 forms an angle greater than or equal to 90° relative to a bottom and radially outer edge of the cylindrical body and less than or equal to 90° relative to an upper and radially outer edge of the cylindrical body to engage the hook of the lineman's pole.

As can be seen in FIGS. 3A to 3D, the flange 200 can extend circumferentially around the upper tube member 84 in a range from 5° to 200° degrees, although other angles can be used. As can be appreciated, the flange 200 can extend different distances and project at different angles relative to a vertical side wall of the upper tube member 84. In some examples, the flange 200 projects outwardly by a sufficient distance to engage the hook. In some examples, the flange 200 projects outwardly by greater than or equal to ¼″. In some examples, the flange 200 projects outwardly by greater than or equal to ¾ of a diameter of the hook.

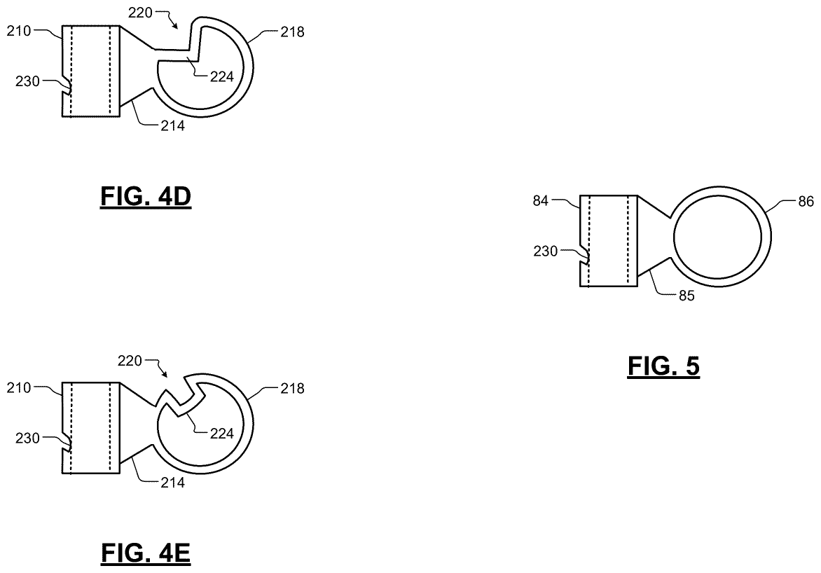

Referring now to FIGS. 4A to 4E, a similar effect can be achieved by altering a shape of an upper side of a pull ring 218. In FIG. 4A, the pull ring 218 includes a hook engaging portion 220. An upper tube member 210 is connected by a flange 214 to the pull ring 218. The pull ring 218 has a generally circular or elliptical shape other than the hook engaging portion 220 that is arranged adjacent to an upper side of the flange 214. In some examples, the hook engaging portion 220 includes an indented portion 224 formed in the pull ring 218. In some examples, the indented portion has a concave shape as shown, although other shapes such as a triangular shape (FIG. 4D), a slotted shape (FIG. 4E), or other shape that allows the hook to engage the cutout door without requiring the hook to pass through the pull ring 218 can be used. In FIG. 4B, the upper tube member 210 includes the pull ring 218 with hook engaging portion 220 and the flange 200. In FIG. 4C, the upper tube member 210 includes the pull ring 218 with hook engaging portion 220 and a cavity 230 extending into the upper tube member 210. In some examples, the cavity 230 extends at an inward and/or downward angle relative to the upper tube member 210 to engage the hook.

As can be appreciated, engaging an upper surface of the pull ring 86 between the flange 85 and the pull ring 86 as shown in FIG. 2A when the cutout door is arranged at an angle relative to perpendicular to the ground may not provide significant enough grip to pull the cutout door. The hook engaging portions shown in FIGS. 4A to 4E provide larger surfaces to allow more positive engagement of the hook of the lineman's pole while still allowing the hook to pass into the pull ring should sufficient time be available.

In FIG. 5, the upper tube member 84 includes the flange 85 and the pull ring 86. The upper tube member 84 includes the cavity 230 extending into the upper tube member 210. In some examples, the cavity 230 extends at an inward and/or downward angle relative to the upper tube member 210 to engage the hook.

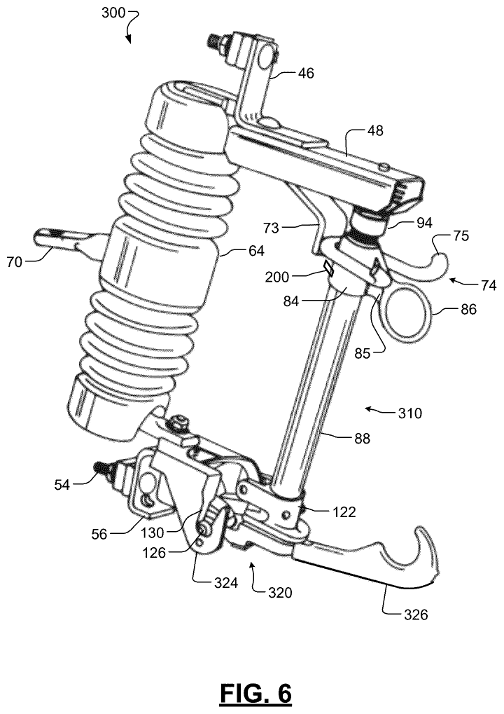

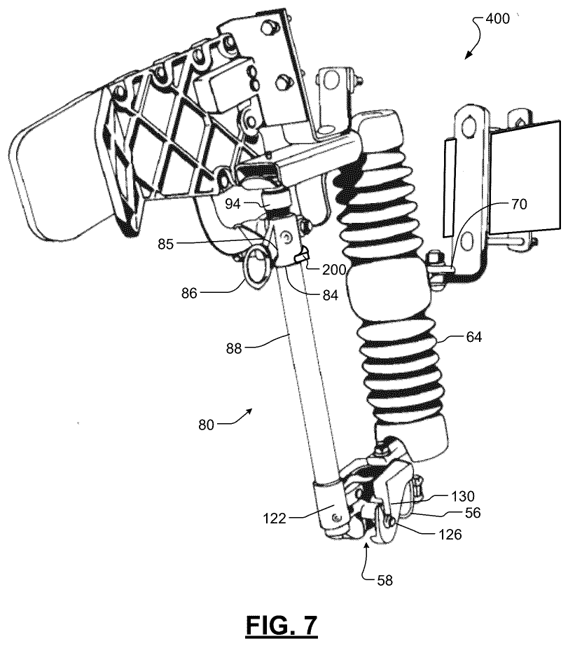

Referring now to FIGS. 6 and 7, the flange 200 (shown) (and/or the modified pull rings in FIGS. 4A to 4C or the upper tube member with the cavity in FIG. 5 (not shown)) can an also be used on other types of cutouts such as a line break cutout 300 (FIG. 6) or a load break cutout 400 (FIG. 7). As described above, a cutout door 310 can be used to break the circuit by swinging open from the top of the cutout door 310 and rotating on a hinge member 320. The lineman can break the circuit using either the pull ring 86 or the flange 200 (and/or the modified pull rings in FIGS. 4A to 4C or the cavity in the upper tube member in FIG. 5). The line break cutout 300 also allows a lineman to break the fuse connection by pulling on a lever 326 extending outwardly from the hinge member 320.

In FIG. 7, the flange 200 (shown) (and/or the modified pull rings in FIGS. 4A to 4C or the upper tube member with the cavity in FIG. 5) can also be used on a load break cutout 400.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. An upper tube member for a cutout door of a power line connection, comprising:
a cylindrical body configured to receive one end of an insulating tube;
a first flange extending in a first radial direction outwardly from the cylindrical body;
a pull ring connected to the first flange, defining a continuous ring opening, and extending in the first radial direction outwardly from the first flange; and
a second flange extending a predetermined distance in a second radial direction, opposite to the first radial direction, from an opposite side of the cylindrical body to engage a hook end of a lineman's pole.

2. The upper tube member of claim 1, wherein the predetermined distance is greater than or equal to three-quarters of a diameter of the hook end of the lineman's pole.

3. The upper tube member of claim 1, wherein the predetermined distance is greater than or equal to a diameter of the hook end of the lineman's pole.

4. The upper tube member of claim 1, wherein the second flange is located adjacent to a bottom edge of the cylindrical body.

5. The upper tube member of claim 1, wherein the second flange extends in a range from 5° to 200° in a circumferential direction around the cylindrical body.

6. The upper tube member of claim 1, wherein the second flange extends greater than ¼″ from the cylindrical body.

7. The upper tube member of claim 1, wherein the second flange forms an angle greater than or equal to 90° relative to a bottom and radially outer side of the cylindrical body and less than or equal to 90° relative to an upper and radially outer side of the cylindrical body.

8. The upper tube member of claim 1, wherein an upper edge of the cylindrical body of the upper tube member is threaded to receive a cap.

9. A cutout door for a power line connector, comprising:
the cap;
the insulating tube;
an arc shortening rod arranged in the insulating tube and connected to the cap;
a fuse arranged in the insulating tube and connected to the arc shortening rod; and
the upper tube member of claim 8.

10. The cutout door of claim 9, further comprising:
a lower tube member arranged around an opposite end of the insulating tube; and
a conductor in contact with the fuse and extending through the insulating tube and the lower tube member.

11. An upper tube member for a cutout door for a power line connector, comprising:
a cylindrical body configured to receive one end of an insulating tube;
a flange extending in a first radial direction outwardly from the cylindrical body; and
a pull ring extending in the first radial direction outwardly from the flange, defining a ring opening, and including opposite ends connected to the flange,
wherein the pull ring has a shape selected from a group consisting of circular and elliptical, and
wherein an upper side of the pull ring includes a hook engaging portion extending into the ring opening.

12. The upper tube member of claim 11, wherein the hook engaging portion has a shape selected from a group consisting of concave, triangular, and slotted.

13. The upper tube member of claim 11, wherein the flange has a trapezoidal shape.

14. The upper tube member of claim 11, wherein an upper edge of the cylindrical body of the upper tube member is threaded to receive a cap.

15. A cutout door for a power line connector, comprising:
the cap;
the insulating tube;
an arc shortening rod arranged in the insulating tube and connected to the cap;
a fuse arranged in the insulating tube and connected to the arc shortening rod; and
the upper tube member of claim 14.

16. The cutout door of claim 15, further comprising:
a lower tube member arranged around an opposite end of the insulating tube; and
a conductor in contact with the fuse and extending through the insulating tube and the lower tube member.

17. An upper tube member for a cutout door of a power line connection, comprising:
a cylindrical body configured to receive one end of an insulating tube;
a flange extending in a first radial direction outwardly from the cylindrical body;
a pull ring having a continuous ring opening, connected to the flange, and extending in the first radial direction outwardly from the flange; and
a notch extending inwardly into the cylindrical body on an opposite side of the cylindrical body relative to the pull ring,
wherein the notch is configured to engage a hook end of a lineman's pole.

18. The upper tube member of claim 17, wherein the notch is located adjacent to a bottom edge of the cylindrical body.

19. The upper tube member of claim 17, wherein an upper edge of the cylindrical body of the upper tube member is threaded to receive a cap.

20. A cutout door for a power line connector, comprising:
the cap;
the insulating tube;
an arc shortening rod arranged in the insulating tube and connected to the cap;
a fuse arranged in the insulating tube and connected to the arc shortening rod; and
the upper tube member of claim 19.

21. The cutout door of claim 20, further comprising:
a lower tube member arranged around an opposite end of the insulating tube; and
a conductor in contact with the fuse and extending through the insulating tube and the lower tube member.
